(19) United States
(12) Patent Application Publication
(10) Pub. No.: US 2026/0240342 A1
(43) Pub. Date: Aug. 20, 2026

(54) HEATED DISPLAY CABINET

(71) Applicant: CARTER-HOFFMANN, LLC, Mundelein, IL (US)

(72) Inventors: Gabriel PALMISCIANO, Mundelein, IL (US); Sreekanth PUSHPALA, Mundelein, IL (US); Kelly MICHALKO, Mundelein, IL (US); Gwen BIALAS, Mundelein, IL (US); Manjunath GOVINDAPPA, Bangalore (IN)

(21) Appl. No.: 18/869,714

(22) PCT Filed: Jan. 25, 2024
(86) PCT No.: PCT/US2024/012959

§ 371 Date: Nov. 26, 2024

Related U.S. Application Data
(63) Continuation-in-part of application No. 18/203,752, filed on May 31, 2023, now Pat. No. 12,022,964.
(60) Provisional application No. 63/442,145, filed on Jan. 31, 2023.
(60) Provisional application No. 63/606,819, filed on Dec. 6, 2023.

(51) Int. Cl. A47F 3/00; A47F 3/02; A47F 11/10; G05D 23/19; G06F 3/14

(52) U.S. Cl. CPC A47F 3/001; A47F 3/02; A47F 11/10; G05D 23/1934; G06F 3/14

(57) ABSTRACT

A cabinet (10) to hold and display a plurality of food items is provided. The cabinet includes a plurality of shelves (52) that each include holding volumes that are accessible via an open front of the cabinet. The cabinet establishes a separate and dedicated air curtain across the opening into each holding volume and the temperature of the air forming each holding volume is separately controlled. Each shelf includes a digital display (57) that can be controlled to display various parameters of the contents of the specific shelves or other material.

### CROSS-REFERENCE TO RELATED APPLICATIONS

This application claims priority from U.S. Provisional Application No. 63/442,145, filed Jan. 31, 2023; U.S. Provisional Application No. 63/606,819, filed Dec. 6, 2023; and U.S. Nonprovisional application Ser. No. 18/203,752, filed May 31, 2023, the entirety of which are each fully incorporated by reference herein.

### BACKGROUND

The subject disclosure relates holding cabinets and specifically holding cabinets that are provided to hold food items for customer access and purchase.

### BRIEF SUMMARY

A first representative embodiment of the disclosure is provided. The embodiment includes a cabinet. The cabinet includes a housing with a top wall, right and left side walls, a lower wall and a rear wall that are collectively arranged to define an internal volume therein, wherein the housing includes an open front to allow access into the internal volume. A plurality of shelves extend within the internal volume, wherein each of the plurality of shelves have a storage volume disposed above the respective shelf, wherein each storage volume is a part of the internal volume, wherein each of the plurality of shelves comprises a conduction heater disposed on the respective shelf that adds heat to a top surface of the respective shelf. Each of the plurality of storage volumes is partially enclosed by a roof within the internal volume and above the respective storage volume, wherein the roof includes an air flow path therethrough and a plurality of apertures at an end of the roof proximate to the open front, wherein the plurality of apertures direct air flowing from the air flow path into the storage volume below the roof in an air flow direction that leaves the plurality of apertures in a substantially a downward direction. A heating assembly is provided in conjunction with each shelf and storage volume, wherein each heating assembly comprises a fan, a heating element, and at least one sensor, wherein the at least one sensor monitors a temperature of air flowing through the roof above the respective storage volume. A is provided and is configured to control operation of the respective fan, the respective heat element, and the respective heater disposed with the shelf of the plurality of shelves associated with the respective storage volume, wherein the controller selectively operates the respective conduction heater, the respective heating element, and the respective fan to control a sensed temperature of air that flows through the air flow path above the respective storage volume.

Another representative embodiment of the disclosure is provided. The embodiment includes a cabinet. The cabinet includes a housing with a top wall, right and left side walls that are collectively arranged to define an internal volume therein, wherein the housing includes an open front to allow access into the internal volume. A plurality of shelves extend within the internal volume, wherein each of the plurality of shelves establish a storage volume disposed above the respective shelf, wherein each storage volume is a part of the internal volume. Each of the plurality of shelves comprises a heating assembly that is fixed with respect to the respective plurality of shelves. Each of the plurality of storage volumes is partially enclosed by a roof within the internal volume and above the respective storage volume and the respective shelf, each storage volume is further enclosed by the right and left walls. The housing pivotably supports a plurality of mechanical compartments, with one of the plurality of mechanical compartments disposed with respect to each shelf, each mechanical compartment is pivotably mounted to the housing and pivotable between a closed position where a first wall of the mechanical compartment forms a rear wall of the storage volume, and between an open position wherein the storage volume is accessible above the mechanical compartment and from a direction opposite from the open front of the housing. The heating assembly is provided in conjunction with each shelf and each mechanical compartment, wherein each heating assembly comprises a fan, a heating element, and at least one sensor, wherein the at least one sensor monitors a temperature within one of the mechanical compartment or the shelf. The cabinet further includes a controller, the controller is configured to control operation of the respective fan and the respective heating assembly.

The representative embodiments include the modifications and additions described in the Numbered Paragraphs provided at the end of this specification.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of a cabinet with a plurality of shelves to hold items, such as food items.

FIG. 2 is another perspective view of the cabinet of FIG. 1 with some of the elements of the housing removed to better see the shelves.

FIG. 3 is a right side cross-sectional view of the cabinet of FIG. 1 that depicts schematically the air flow path through one of the shelves and associate air movement structure associated with the shelf.

FIG. 4 is a detail view of FIG. 3 depicting one of the shelves within the cabinet.

FIG. 5 is a rear view of the cabinet showing the internals of the heating volumes associated with the cabinet.

FIG. 6 is a detail view of FIG. 4 depicting one of the heating volumes.

FIG. 7 is a perspective view of another cabinet with a plurality of shelves, similar to and constructed similar to the cabinet of FIG. 1 with some additional features, and depicted as receiving a food product and a plurality of trays thereon.

FIG. 8 is a view of the rear side of the cabinet of FIG. 7 with a back panel removed to display the heating compartments for each of the plurality of shelves.

FIG. 9 is a detail view of the upper two heating compartments of the view of FIG. 8.

FIG. 10 is another side view of the cabinet of FIG. 7.

FIG. 11 is a detail view of detail Z of FIG. 10.

FIG. 12 is rear perspective view of an alternate cabinet with the plurality of mechanical compartments associated with the plurality of shelves all in the closed position.

FIG. 13 is the view of the cabinet of FIG. 12 with all of the mechanical compartments in the open position to allow access into the spaces above the shelves from the rear side of the cabinet.

FIG. 14 is a left side cross-sectional view of the cabinet of FIG. 12 with the top mechanical compartment in the open position and the remaining mechanical compartments below the top mechanical compartments in the closed position.

FIG. 14a is a view of detail AA from a perspective view slightly offset from the side view of FIG. 14.

FIG. 15 is a view of a spring that can be used with one or more of the mechanical compartments of FIG. 12.

FIG. 16 is a side view cross-sectional view of the housing with one of the mechanical compartments in the open position.

FIG. 17 is a detail view of detail AA but with all mechanical compartments in the closed position.

### DETAILED DESCRIPTION OF THE PREFERRED EMBODIMENTS

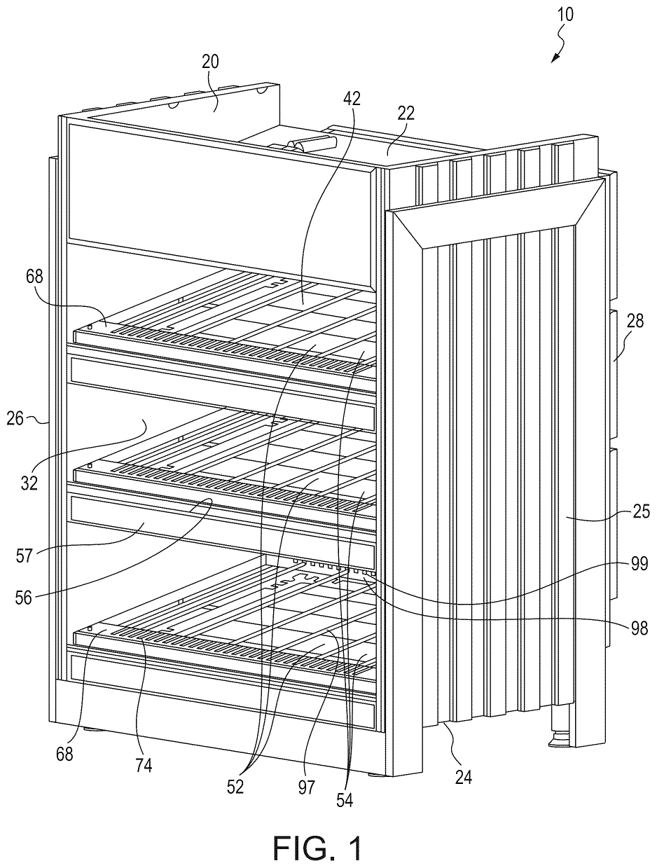

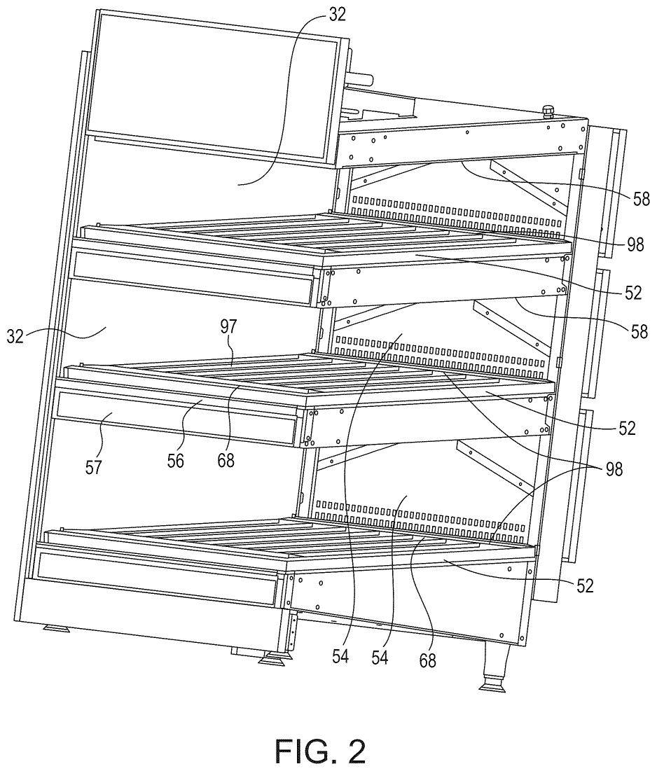

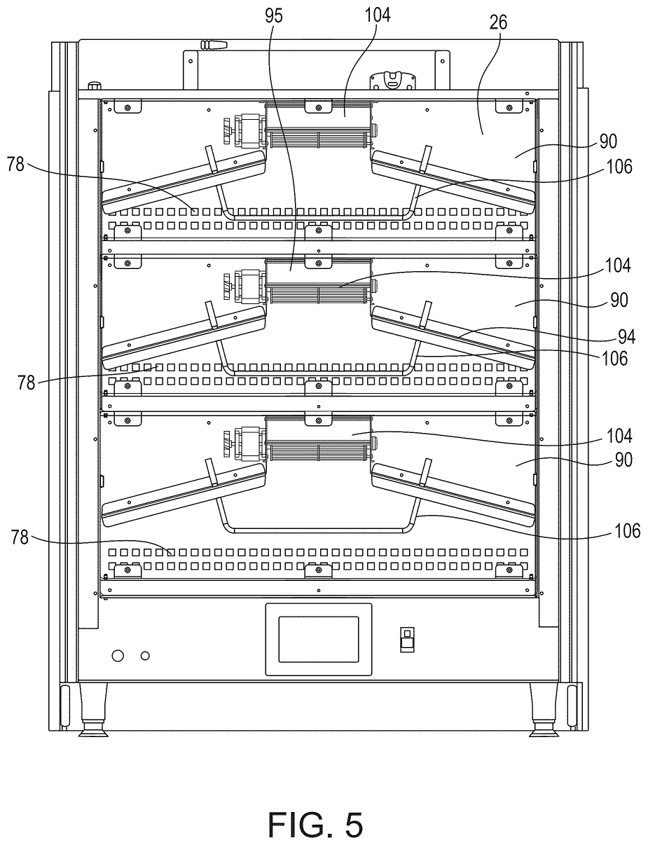

Turning now to FIGS. 1-6, a heated display cabinet 10 is provided. The cabinet 10 may be configured to supporting and displaying food items, such as prepackaged food or drink items, locally prepared food items or drinks, or the like. The cabinet may be configured for supporting non-food items desirable for individual sale, which may be maintained for the point of sale in a heated or cooled environment. While the cabinet 10 may be configured to supporting and displaying various foods, drinks, and non-edible items, for the sake of brevity the term “food item” used henceforth in this specification shall include each of food items, beverages, or non-edible items unless the specifically referring to one specific type of item below.

The cabinet 10 is configured to store a plurality of food items in an organized manner, such as in multiple rows that are formed upon each shelf 52, one or more shelves 52 provided. The cabinet 10 may include a heating system or a cooling system, or in some embodiments, both a heating and a cooling system. In these embodiments, some of the plurality of shelves may be configured with a heating system, while others of the plurality of shelves may be configured with a cooling system.

In some embodiments, the cabinet 10 includes a plurality of shelves 52, such as three, four, or five shelves, that each have the same size and orientation and each extend within the internal volume 32 of the housing. In some embodiments, each of the plurality of shelves 52 may extend in the same orientation within the housing such that the shelves are each parallel to each other. In some embodiments, each shelf 52 may extend along or parallel to a line 1001 that is at an acute angle (Θ) to the surface 2000 that housing rests upon. In these embodiments, the acute angle Θ may be aligned such that a front portion of each shelf (proximate to the open front 31 of the cabinet 10) is at a lower position than the remainder of the shelf, such that the force of gravity acting upon the food items within the shelf tend to urge the food products toward the front portion of the shelf (assuming that the mass of the food item allows the food item to slide upon the top surface of the shelf 52 due to the force of gravity). In some embodiments, the acute angle Θ may be about 20, or about 25, or about 30 degrees. In some embodiments, the acute angle may be within a range of about 10 degrees to about 30 degrees, inclusive of all angles within this range. The term “about” is defined to include the recited term plus or minus 10% of the value of the recited term.

The shelves 52 may each extend through the inner volume 32 of the housing from the rear wall 28 (either directly from such that each shelf 52 is directly in contact with or from a position that is adjacent from the rear wall 28) and to a position where a front end portion 52a is proximate to the opening into the internal volume 32 of the housing. Each shelf may include a top surface 53 that is a flat surface. Each shelf may extend across the entire width of the housing, and specifically the inner volume 32 of the housing 20, while in other embodiments, each shelf may extend only a portion of the width of the housing and be spaced from the right and left side walls 25, 26 of the housing 20.

The shelves 52 define a storage volume 54 that is within the inner volume 32 of the housing, and specifically within the space above the shelf 52 and below a roof 58 that is spaced above the shelf and faces the shelf 52. The storage volume 52 is the volume above the shelf 52 that the food products 3010 are received and arranged. In some embodiments the roof 58 is parallel with the shelf 52 that is positioned directly below the roof 58.

One, some, or all of the shelves 52 include a stand-off 68 that is disposed at or proximate to a forward portion 52a of the shelf 52. The stand-off 68 is a portion that is either formed monolithically with the shelf or is attached to the shelf and extends upwardly above the upper surface of the shelf 52. The stand-off 68 may extend across the entire width of the shelf or for one or more portions of the width. A front surface of the stand-off may be flush with a front surface 56 of the shelf 52, or the front surface of the stand-off may be positioned behind the front surface 56 of the shelf 52.

The stand-off 68 preferably includes a plurality of apertures 74 arranged thereon. In some embodiments, each embodiment is at a consistent spacing from the one or both apertures that are adjacent to the specific aperture 74 such that all apertures along the stand-off are at a consistent spacing. In other embodiments, the apertures are arranged with differing spacing between different adjacent apertures 74. The apertures 74 may be elongate and extend from a rear upper edge 69a (i.e. the edge between the upper facing surface 68a and the rear facing surface 68b) blindly toward the front upper edge 69b, but not reaching the front upper edge. In some embodiments, the aperture 74 may also extend from the rear upper edge blindly along the rear facing surface blindly. Each of the apertures may, when provided upon the rear facing surface 68b, extend blindly the same distance below the rear upper edge 69a. In some embodiments, the stand-off 68 is hollow and therefore the apertures are simply holes cut through the surface of the stand-off that form upper facing surface 68a and in some embodiments the rear facing surface 68b. In other embodiments, the stand-off 68 is a solid piece, and the apertures 74 are actually slots that are formed blindly into the stand-off that extend through the upper facing surface 68a and, in some embodiments, the rear facing surface 68b.

The use of the term “front facing surface,” “upper facing surface,” and “rear facing surface” are related to the principle direction that these surfaces face. For example, because, in some embodiments, the shelf 52 that the stand-off rests upon is oriented at an angle Θ with respect to the surface 2000 that the housing 20 rests upon, and because the stand-off is a rectangular (or square) structure, the front, upper, and rear facing surfaces (68c, 68a, 68b) do not face exactly in the front, upper (i.e. opposite from the surface 2000) and the rear direction (i.e. toward the rear wall 26 of the housing). Instead these surfaces face in a direction that is offset by the angle Θ from those directions. For example, the upper facing surface 68a faces at an angle that is the angle Θ away from vertical, with the front and rear facing surfaces 68c, 68b facing in a direction that is also offset at the angle Θ from the horizontal. Nevertheless, in these embodiment the upper facing surface 68a, for example, faces in a direction that has a vector component that is vertically upward and a second vector component that is horizontally out of the housing—but this surface is called the “upper facing surface” because it faces generally upward. The same is true with the front and rear facing surfaces 68c, 68b.

In some embodiments, a rear stand-98 is provided upon one or all of the shelves 52. The rear stand-98 may be the same height above the shelf as the respective front stand-off 68 for the same shelf, although in other embodiments, the rear stand-off 98 may be taller (distance above the upper surface of the shelf) than the front stand-off. The rear stand-off may also have a plurality of apertures 99, which may all be disposed at a consistent spacing from the adjacent apertures, or they may be at differing spacings along the stand-off. In preferred embodiments, the position of each aperture 72, 99 on the front and rear stand-offs 68, 98 are in the same position. The apertures 99 in the rear stand-off may extend blindly along a portion of the upper facing surface 98a to the front edge and in some embodiments blindly below the front edge along the front facing surface 98b. The apertures 72 and 99 are provided to removably receive a divider 97 that extends along the shelf between both front and rear stand-offs 68, 98, to serve to align food products in a front to back row upon the shelf, and to separate neighboring rows of food products upon the shelf. The dividers 97 may be tubes, or cylinders, or planar members or other shapes and orientations, such that one end of a divider is received within the front aperture 72 and the opposite end is received within the rear aperture 99, with the dividers being maintained in position by gravity.

In some embodiments the apertures (that extend through the rear facing surface 68a of the front stand-off and the front facing surface 98b of the rear stand-off 98) causes the divider 97 to be positioned above the upper surface of the shelf 52, to provide a space 96 between the shelf 52 and the divider 96. This space 96, when provided, allows for air flow therethrough which increases the possible mixing of the air through the storage volume 54 (discussed below). The space 96 also allows air to extend below the dividers, which will allow air to impinge upon the bottom portion of each food item that is disposed upon the shelf 52.

In some embodiments, each shelf 52 may include a dedicated heating volume 100 that is fixed with respect to the shelf 52. The heating volume 100 may be fixed to the rear wall 26 of the housing 20 and positioned to receive air flow the storage volume 54 above the respective shelf in a continuous manner during operation, when the forced air system, discussed herein, is operating. In some embodiments, the heating volume 100 may be fixed directly to the rear wall 26, while in other embodiments the heating volume may be fixed with respect to the shelf 52 and with respect to the rear wall 26 in such a manner that the heating volume 100 receives air from the storage volume 54.

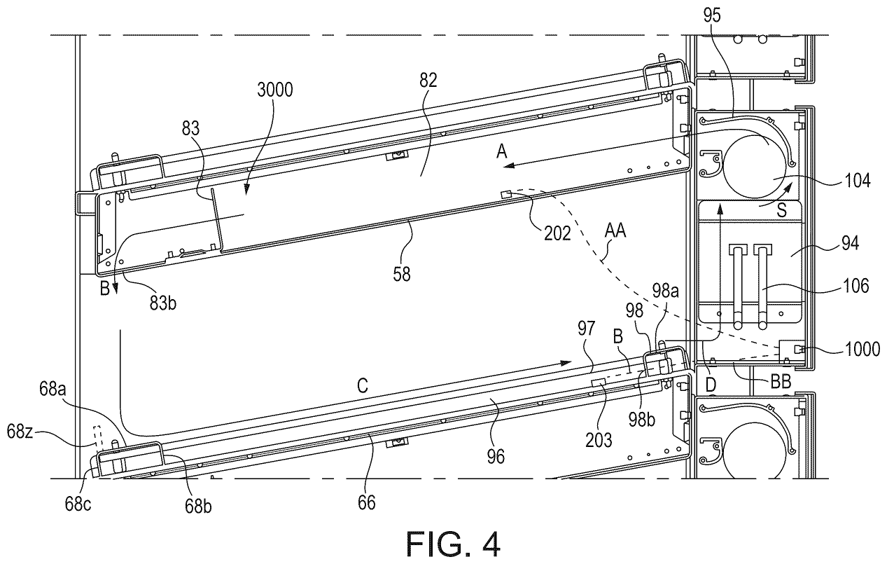

The heating volume 100 is best shown in FIGS. 4, 5 and 6. In some embodiments, there are provided a dedicated heating volume 100 for each shelf 52, with the components of each heating volume 100 controlled based upon sensed parameters associated with each shelf 52. In other embodiments, there may be a single heating volume 100 that interacts with each shelf, with air flow structures provided for each shelf to control the air the flows with respect to each shelf from the single heating volume.

Each heating volume 100 includes a fan 104 and a heating element 106. The heating element may be one or more resistance heaters, or it may be other types of heating elements known in the art. The heating element 106 may be positioned within the heating volume 100 to cause air that is draw into the heating volume 100 to pass by the heating element, i.e. with a single pass or in some embodiments multiple passes by the heating element if structure to baffle the flow within the heating volume 100 is provided, such that the air is heated before reaching the fan 104.

The fan is configured to draw suction from air within the heating volume 100 and discharge air into (or toward) the air flor path 84 through the roof 58 above the respective shelf 52. The air flow path 84 may be directly connected to the discharge of the fan 104, or there may be an intermediate conduit that directs air from the fan 104 to the air flow path.

The heating volume 100 may include a baffle 94 disposed therein to direct air that enters the heating volume 100 to flow toward the suction of the fan 104.

The heating volume 100 may include a second baffle 95 that is provided with the fan 104 to direct air flowing through the fan toward the desired discharge point—i.e. the second baffle 95 prevents air from leaving the fan discharge in a direction other than toward the air flow path 84.

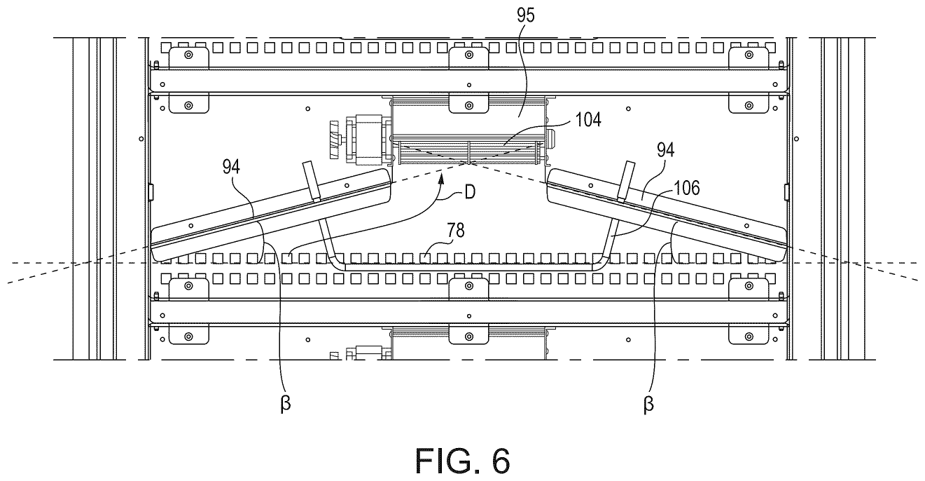

The air flow path 3000 is best understood with reference to FIGS. 4 and 6. The air flow path 3000 extends from the discharge of the fan 104, as urged as the fan 104 rotates in the direction S (FIG. 4) and the air discharging from the fan travels from the heating volume 100 into the air flow path, as shown in arrow A (FIG. 4). Air flows through the air flow path 84 until it reaches an end thereof which is proximate to the open end of the housing 20. As air flows through the air flow path 84, in some embodiments, air flows past a sensor (202, schematic) that senses the temperature of the air flowing therepast. The sensor 202 send a signal (AA, schematic) to a controller 1000 (FIG. 4, schematic) which is discussed in detail below. In some embodiments, the air flow path 84 may include one or more baffles 83 that require the air to flow in specific directions within the air flow path or in some embodiments through apertures. The baffles 83 may be provided to adjust the pressure within the air flow path 84 to accordingly adjust the air flow rate and air pressure of the air that leaves the air flow path and flows into the heated volume 54.

Air flows from the air flow path 84 and into the heated volume through one or a plurality of apertures 83b that are provided at the end portion of the roof 58 and direct the air in a substantially downward direction into the heated volume 54 and toward the shelf 52 directly below the roof 58—as depicted in air flow B (FIG. 4). This air flows initially downward (in some embodiments directly downward, or in other embodiments generally downward—i.e. with a significant downward vector components but potentially also with a minor horizontal vector component—with the term substantially downward specifically including both possibilities within its scope) and the air flow direction is a function of the angle of the roof 58 and specifically the location of the apertures 83b within the roof 58. One of ordinary skill in the art with a thorough review of this specification and figures will understand how to position and align the holes 83b with respect to the roof for a desired direction of air flow with merely routine optimization.

The air that leaves through the holes 83b and is directly downwardly establishes an “air curtain” across the opening 32 into the housing and specifically the storage volume 54 above the shelf. The air curtain is provided to establish a barrier between the storage volume 54 and the atmosphere surrounding the outside of the housing, which may assist with maintain the temperature controlled environment within the storage volume 54 as desired. The air curtain may also prevent or minimize unwanted items-such as dust, or insects, or smells from crossing the air curtain and into the storage volume 54, and may also prevent smells from leaving the storage volume 54 through the air curtain.

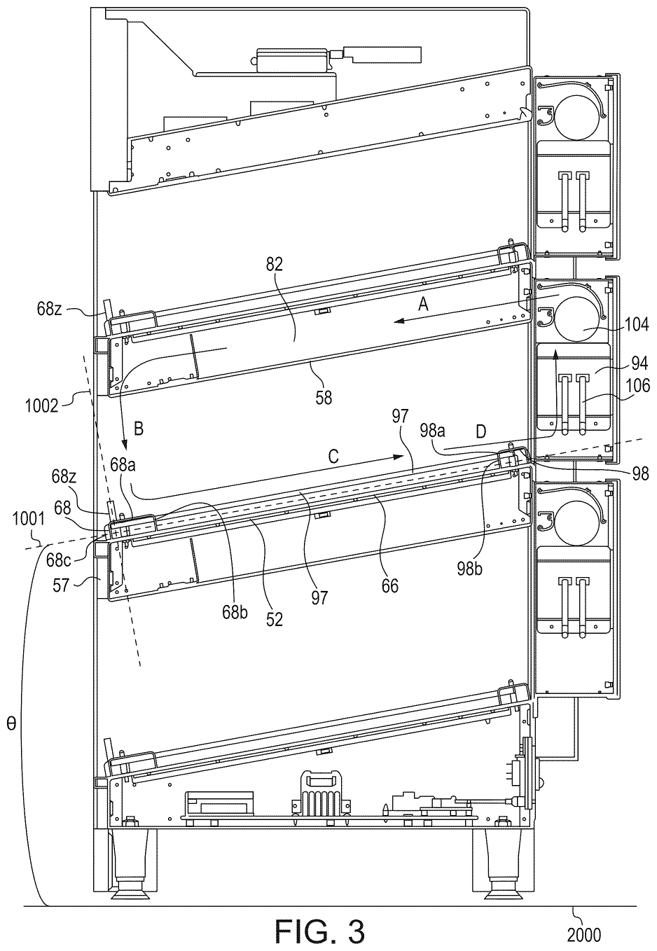

The air flow B that establishes the air curtain may turn inwardly to flow generally across the surface of the shelf 52 and toward the rear wall 26 of the housing, as depicted as arrow C in FIG. 4. In some embodiments, (FIGS. 3, 4) the first (front) stand-off 68 may support a fence 68z that extends upwardly from the stand-off 68, to which a portion of the air curtain flows past, and directs that flowing air inwardly into the storage volume. The air flowing downwardly via the air curtain is urged to turn inwardly due to the front stand-off 68 and the shelf, and due a suction that extends through the apertures 78 provided within the rear wall 26.

The air flow C flows through the storage volume 54 and across the shelf 52 and past any food items that resting upon the shelf. Air reaching the rear end of the storage volume 54 flows through the plurality of apertures 78 in the rear wall 26 (or other structure the establishes the rear boundary of the storage volume 54) and flows into the heating volume 100—as depicted as air flow D (FIGS. 4, 6). When entering the heating volume 100, the air passes across or proximate to the heating element 106, thereby increasing the temperature of the air flow and is directed to the suction of the fan 104, as urged by the baffle 96 when provided. The air then cycles again as discussed above.

As discussed herein, the cyclic air flow (paths A, B, C, and D) is urged by the fan 104 and heated by the heating element 106. The controller 1000 is provided to monitor the temperature of the air flowing through the air flow path (via sensor 202) and uses conventional feedback control to control the duty cycle of the heating element 106 to maintain the temperature flowing through the air flow path either as close as possible to a desired temperature, or in some embodiments, within a temperature range. The desired temperature (or temperature range) may established by the controller with reference to a set of programmed temperatures or ranges for various different foods that might be stored within the storage volume 54 and selected by the controller 1000 with a user input of the food items that are stored within the storage volume at that time. The user may input the information to the controller either via a data entry device located directly upon the cabinet, or in other embodiments, via a remote data entry (either a remote computer or a POS system). The controller 1000 may communicate with the remote data entry device (when provided) via Wi-Fi, Bluetooth, or other non-wired communication protocols, or via a wired connection.

In some embodiments, the controller 1000 controls the speed of fan 104 rotation to control the mass flow rate of air that is moved through the system to establish the air curtain and to provide heating/cooling to the storage volume 54. In some embodiments, when an air curtain is not desired, the fan 104 can be stopped. In these circumstances the heating element 106 is typically also turned off and the conduction heater 66 is used to adjust the temperature with the storage volume 54.

In some embodiments, one, some or all of the shelves 52 may include a conduction heater 66 thereon, which when operating supplies heat to the top surface of the shelf 52 and therefore to food items that are disposed upon the shelf 52. The conduction heater 66 may form the top surface of the shelf 52 or in other embodiments it may be below the top surface of the shelf, and within the materials that form the shelf 52, both possibilities are defined herein as on the shelf. The shelf 52, below the conduction heater 66, may be insulated to prevent a significant flow of heat from the conduction heater 66 downward therefrom, either into the air flow path 82 associated with the shelf that is located in the roof below the shelf that includes the heater, or into the bottom floor of the housing for the bottom-most shelf 52. The controller 1000 may operate the conduction heater using feedback control to maintain the temperature of the air within the air flow path 84 at or close to the desires temperature, or within the established temperature range, as discussed above.

In some embodiments, a second temperature sensor 203 (FIG. 4, schematic) may be provided and sense a temperature at or proximate to the top surface of the shelf 52. The second sensor 203 sends a signal to the controller (BB—schematic) to the controller 1000 related to the sensed temperature. The controller may control the duty cycle and of the conduction heater 66, and/or may control the magnitude of heat generated by the conduction heater 66 to maintain the sensed temperature by the second sensor 203 close to a desired setpoint, or within a desired range. The controller 1000 may use temperature feedback controller to operate the conduction heater 66, either individually or in combination with the heating element 106 using temperature feedback control. One of ordinary skill that reviews and fully understands this specification would be capable of programming the controller 1000 to operate the conduction heater 66 independently, or in concert with the heating element 106 to maintain the sensed temperatures 202, 203 close to the desired temperature or within temperature bands with only routine optimization.

In some embodiments, one, some or all of the shelves 52 and related storage volumes may be cooled in addition to or in alternative to heating. In some embodiments, one, some, or all of the shelves may include one or more Peltier coolers, a chilled water system, or other air conditioning systems as are known in the art. The cooling components may be provided in the heating volume 100 (which in this circumstance provides cooling notwithstanding the name “heating volume”) or within the air flow path 82. The cooling system may be operated by the controller 1000 to maintain a desired temperature that is lower than ambient, or in other embodiments, the heating and cooling systems may be operated with respect to each other as needed by the controller 1000 to maintain the sensed temperature within a desired range.

In some embodiments, one, some, or all of the shelves 52 may include a digital display 57 that is positioned upon the forward facing surface 56 of each shelf 52. The digital display 57 is operated by the controller 1000 (or in other embodiments a different controller than the controller that controls the temperature within the cabinet) in order to display various items, such as advertisements, inventories of the food items disposed upon the shelves, prices of the food items, biographic information (e.g. when fresh food, or recently cooked or prepared food is upon the shelf a “prepared on” time/date can be provided upon the display), sales or special offers associated with the food items, images of the food items (actual images, or trademarks associated with the food items), and/or other items such as news, sports scores, weather, traffic reports, and the like. The digital display may be capable of a continuously moving display or static displays.

In some embodiments, the display screen 57 may be capable of displaying one, some, or all of numbers, words, symbols, or pictures that are associated with food items that are intended to be disposed within the storage volume above the respective shelf. In some embodiments, the controller 1000 may operate in conjunction with an inventory management system, such as the POS system, to display the number of food items that are included within the storage volume. In some embodiments the display may include specific and different displays that are aligned with the various rows of food items included upon a single shelf as aligned by the dividers 97 as discussed above. In some embodiments, the housing 20 may include sensors that are disposed proximate to the opening 32 into the cabinet that can identify when food items are inserted into and removed from the shelf through the opening, and in conjunction with the controller can update the display (such as a display listing the current inventory of the number of food items within each row) as the inventory changes due to inserting or removing food items. The sensor may be an RFID sensor, a code reader (i.e. a QR or UPC code reader) or other types of sensors known in the art or developed in the future to perform the functionality of identifying food items based upon their appearance and shape or based upon code markings upon the food items.

In some embodiments, the display screen 57, and therefore the controller that operates the display screen 57 may communicate with the POS system and/or with a server (local to the establishment that includes the cabinet 10 or a remote server) such that the display can be altered local or remotely. In circumstances where the controller can communicate with a remote server, the remote server can in real time update the display-such as with updated pricing information, updated advertisements, updated news, weather, sports scores, and the like. The communication between the display screen and a remote server may allow for, for example, an entity that has multiple stores with the same cabinet (or similar cabinets) to simultaneously change the display screens for different cabinets at different facilities.

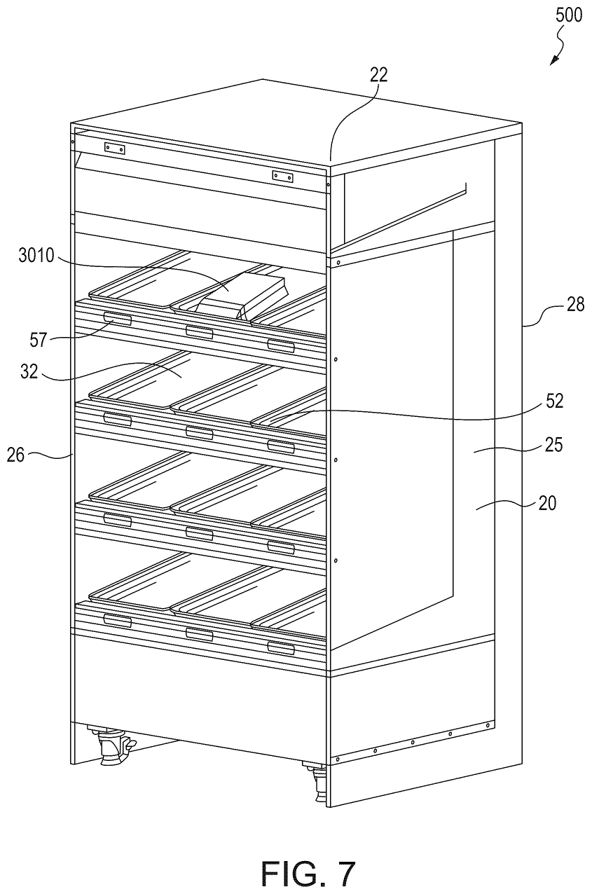

Turning now to FIGS. 7-11, a further embodiment of a cabinet 500 is provided. The cabinet 500 includes the same structure that is included within the embodiments discussed above unless specifically discussed herein, and like element numbers for the same structure in the cabinet 500 depicted herein as with the cabinet 10 are used for the sake of simplicity, and components of cabinet 500 that are not specifically discussed below are the same features as discussed with respect to cabinet 10 (even if not specifically identified in the drawings within FIGS. 7-11). The cabinet 500 includes a plurality of shelves 52, such as 4 shelves as depicted, but other numbers of shelves are possible such as three, or five shelves, that each have the same size and orientation and extend within the internal volume 32 of the housing. In some embodiments, all of the shelves 52 extend in parallel with each other. As with the embodiment below, the shelves may extend along or parallel to a line 1001 that is at an acute angle (Θ) to the surface 2000 that housing rests upon. In these embodiments, the acute angle Θ may be aligned such that a front portion of each shelf (proximate to the open front 31 of the cabinet 10) is at a lower position than the remainder of the shelf, such that the force of gravity acting upon the food items within the shelf tend to urge the food products toward the front portion of the shelf (assuming that the mass of the food item allows the food item to slide upon the top surface of the shelf 52 due to the force of gravity). In some embodiments, the acute angle Θ may be about 20, or about 25, or about 30 degrees. In some embodiments, the acute angle may be within a range of about 10 degrees to about 30 degrees, inclusive of all angles within this range. The shelves are arranged and constructed in the same manner as the shelves 52 discussed above.

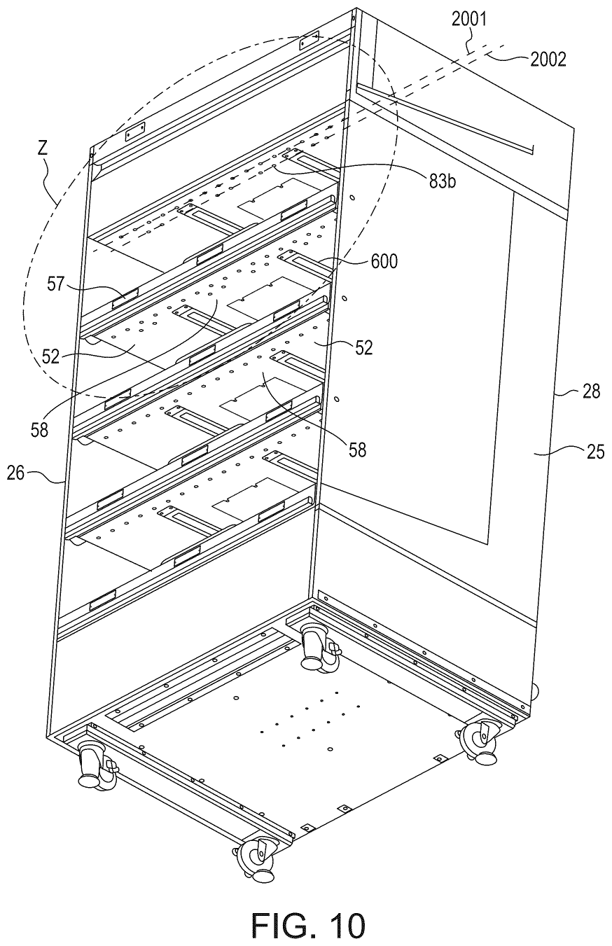

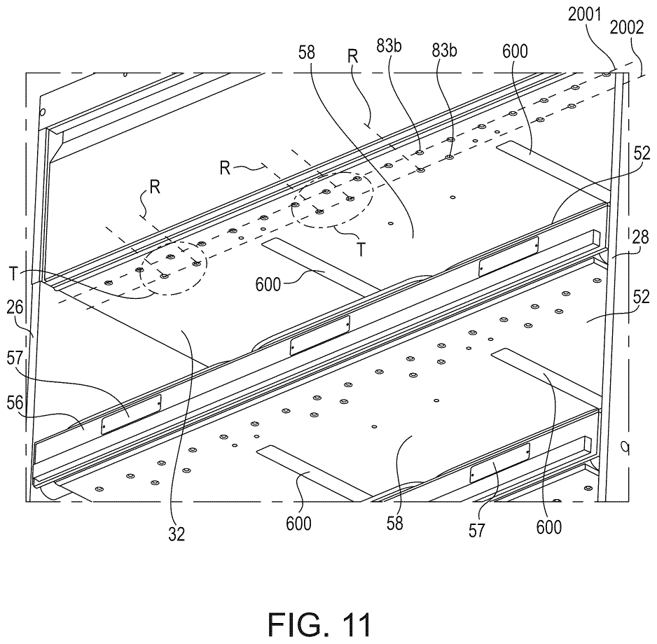

As depicted in FIGS. 10 and 11, the shelves 52 may each include a plurality of apertures 83b that are aligned proximate to a front end portion of the roof 58 to direct the air flowing though the shelf in a substantially downward direction in the heated volume 54 and toward the shelf 52 below the roof 58 (as depicted in air flow B (FIG. 4)) to establish an air curtain as discussed with the above embodiment, with the air flow in this embodiment consistent with the above embodiment as modified per the discussion herein. In some embodiments, the apertures 83b on the roof are positioned along a line 2001 that is parallel to a front face of the housing. In some embodiments, the apertures 83b are also positioned along a second line 2002 that is parallel to line 2001 and positioned slightly inboard of the line 2001 of apertures. In some embodiments, there are more apertures 83b in the line 2001 that is closer to the open front than the second line 2002 that is further from the open front.

In some embodiments, there may be a plurality of groups T of apertures 83b that extend long the second line 2002. The groups T may be equally spaced through a width of the shelf 52, while in other embodiments, and as depicted in detailed FIG. 11, the groups T may be positioned in clusters that are spaced from each other. Each of the apertures within a cluster may have a consistent spacing from each adjacent aperture within the same cluster, while outermost apertures within each cluster are spaced from adjacent apertures in differing clusters with a spacing that is larger than the spacing between adjacent apertures within the same cluster.

In some embodiments, the apertures within groups T may be two apertures 83b that are positioned in a location at a midpoint between two apertures within line 2001 (line R, FIG. 11), i.e. in this embodiment, the two apertures 83b in the group T within line 2002 are positioned with the two gaps within a set of three apertures within line 2001. In other embodiments, the groups T may have three grouped, and consistently spaced apertures 83b that are arranged with respect to four apertures 83b within the first line 2001. The apertures 83b in the second line 2002 may be between apertures in the first line (i.e. lines R, FIG. 11) or they may be positioned in rows with apertures 83b from the first line 2001. In this arrangement, the volume flow rate of air that forms the curtain is increased in local areas proximate to the groups T-which are spaced from each other along the width of the shelf. This has been found to improve the air curtain by increasing the mass-flow rate of air establishing the air curtain at several localized areas along the width of the shelf 52.

In some embodiments, the shelves 52 may each include two or more lights 600 that are positioned above the respective shelf to provide illumination to the shelf 52, and the contents upon the shelf. For the upper-most shelf, the roof above the shelf may include lights 600. The lights 600 may one or a combination of several LEDs that are controlled by the 1000. The lights 600 may be constantly on, or may be controlled via various routines.

For example, the lights 600 may illuminate, or change the brightness and/or the color of illumination and/or flash on and off repeatedly when a sensor (not show) identifies that an object passes into the housing and above the shelf 52. The lights 600 may illuminate and/or change brightness, and/or flash repeatedly based upon instructions from the controller 1000. The instructions may sent to change color, flash, change intensity at random or periodic times, or when a sensor identifies that a person is proximate to the housing. The controller 1000 may communicate with a point of sale system, or an inventory management system and provide instructions for the lights to change color, and/or intensity, or flash when it is desired to identify or promote the products within the housing, and in some embodiments upon certain shelves, or even certain positions upon certain shelves. The controller 1000 may be programmed to operate different lights 600 on different shelves, or even different lights 600 upon the same shelf differently at the same time to provide differing indications. The controller 1000 may operate the digital display 57 associated with the shelf at the same time as operating the lights 600 that shine down upon the same shelf to further promote and call attention to the housing.

One of ordinary skill in the art with a thorough review of the as—filed specification will understand how to program a controller 1000 (or operate the controller 1000 via a system in communication with the controller 1000—i.e. a local point of sale system, or in some embodiments a system that communicates with systems in various affiliated locations—i.e. a franchisor based system that can communication with point of sale systems and local controllers 1000 for systems 10 in various franchisee locations) in order to call attention to shelves 52 and the products positioned upon the shelves 52 with an intelligent and creative use of the digital display 57 and/or the lights 600 (i.e. with flashing, color changing, and or changing intensity lights 600 in conjunction with words and images upon the digital display) to provide interest and excitement to customers that are positioned near the cabinet 10.

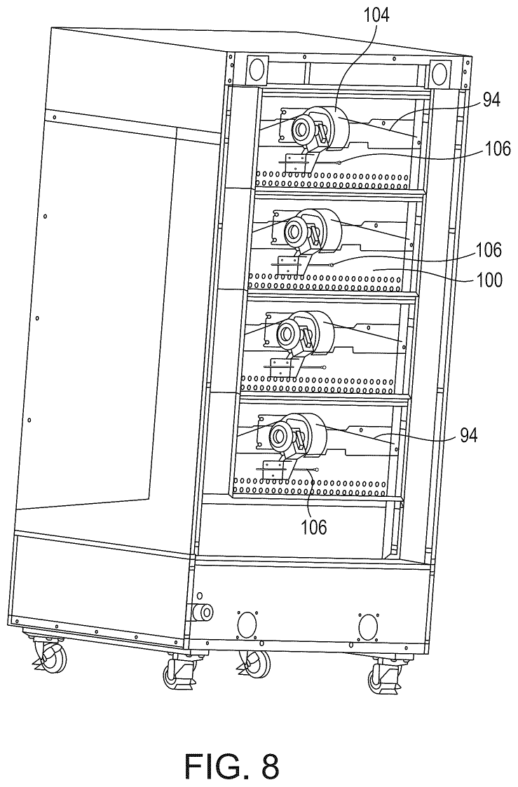

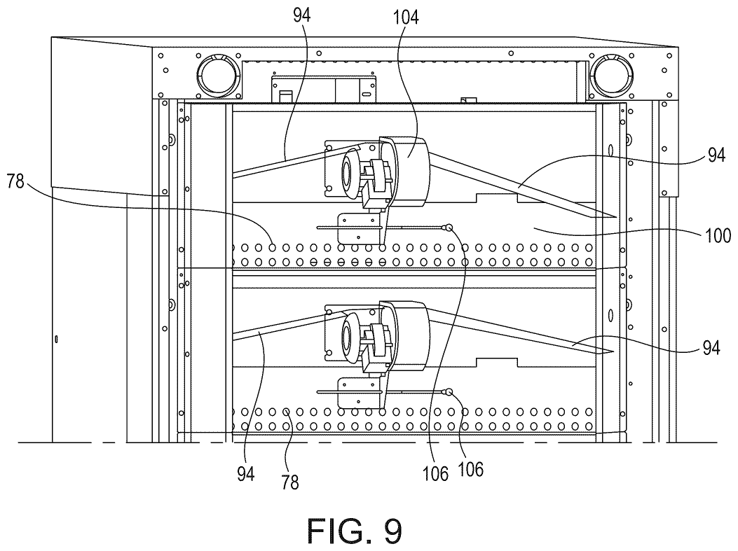

With reference to FIGS. 8 and 9, the fan 104 that is associated with each heating volume 100 may be a blower, such as a squirrel cage blower as depicted in FIGS. 8 and 9. The heating volume 100 may include baffles 94, as depicted in FIG. 9. The baffles urge air flowing through the apertures 78 (air flow path D—FIG. 4) past the heating element 106 and to the suction of the fan 104. The discharge of the fan 104 urges air into the air flow path 82 (A—FIG. 4) as discussed with respect to the embodiment above. As best shown in FIG. 6, the baffle 94 may extend across the width of the heating volume—which is approximately the width of the respective shelf 52 that is adjacent to the heating volume, and the baffle 94 extends across all of the plurality of apertures 78 that extend through the rear wall 26 (or other structure that separates the storage volume 54 and the heating volume 100, either directly or indirectly). The baffle 94 may include two or more segments that are positioned to direct air flowing through the apertures 78 to the suction of the fan 104. As depicted in FIG. 6, the baffle 94 may be positioned at an angle β with respect to the horizontal (i.e. the surface that the housing rests upon). The angle β may be about 10 to about 30 degrees, such as about 10, 15, 20, 25, or 30 degrees, inclusive of all angles within the range of about 10 degrees to about 30 degrees. In other embodiments, the baffle 94 may include an arcuate shape such with an increasing local angle β as the baffle gets closer to the suction of the fan 104.

The baffles 94 and the fan 104 may be arranged to expel air into the shelf 52 (arrow A—FIG. 4). In some embodiments, the width if the shelf along its length (and specifically the portion of the shelf 52 that includes air flow path A) may narrow along its length toward the front end of the shelf. This narrowing increases the pressure at the apertures 83b, which increases the air speed of the air flowing out of the apertures 83b to establish the air curtain (arrow B—FIG. 4). The shelf 52 may include internal baffles 83 that establish the air flow path within the shelf to form a nozzle or a venturi, which further increases the pressure and flow speed. In some embodiments, baffles like baffles 83 of the cabinet 10 may be provided to smooth out the flow, such as at an angle (such as 45 degrees) within a top front corner within the shelf to urge air flowing along the length of the shelf (arrow A—FIG. 4) to transition to a vertical flow (arrow B—FIG. 4) to flow though the apertures 83b and out of the shelf. One of ordinary skill in the art with a thorough review of this specification will understand how to use one or more baffles 83 within the shelf 52 to smooth out the flow, i.e. to maintain laminar flow, yet still design the geometry and the baffles within the shelf to increase the speed of the flow through the apertures 83 with only routine optimization.

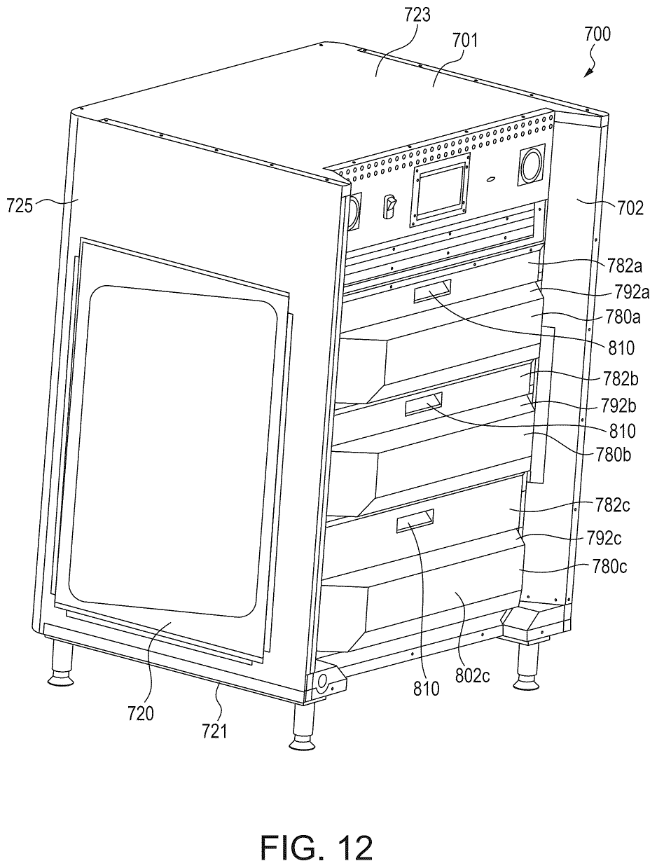

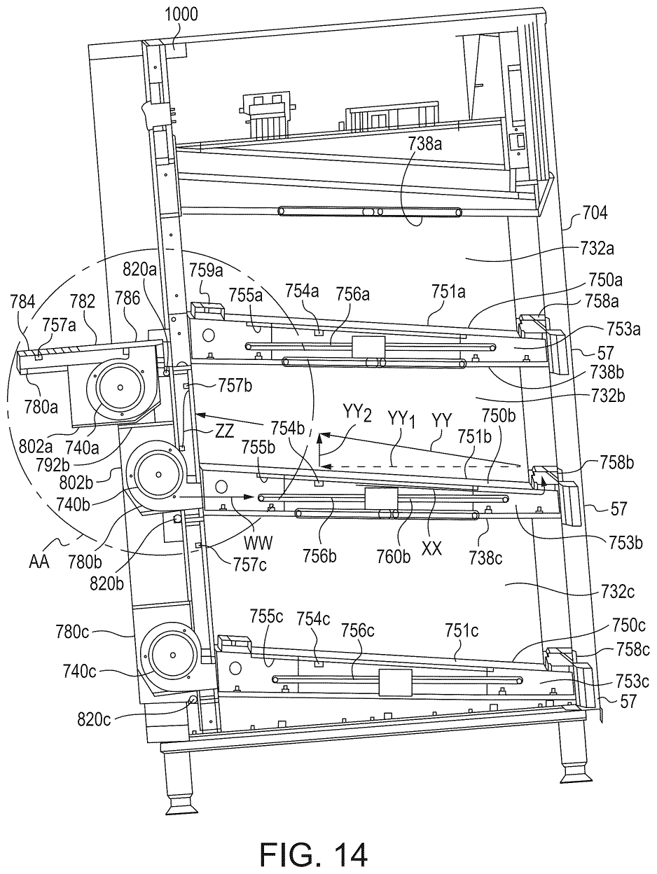

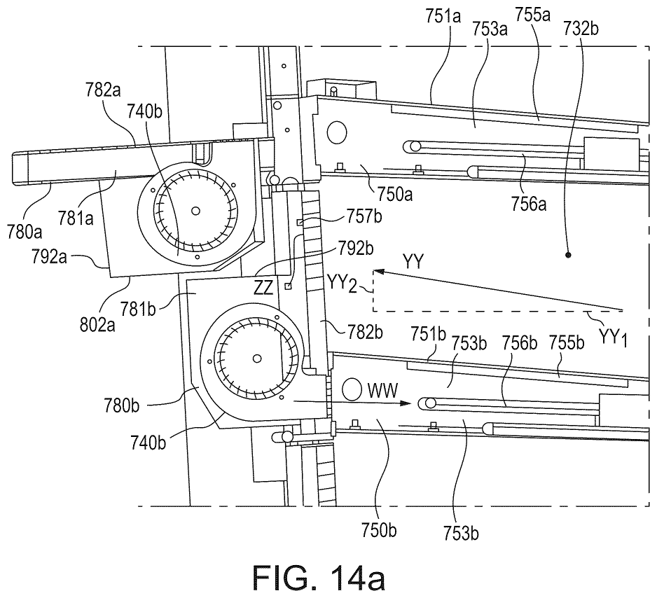

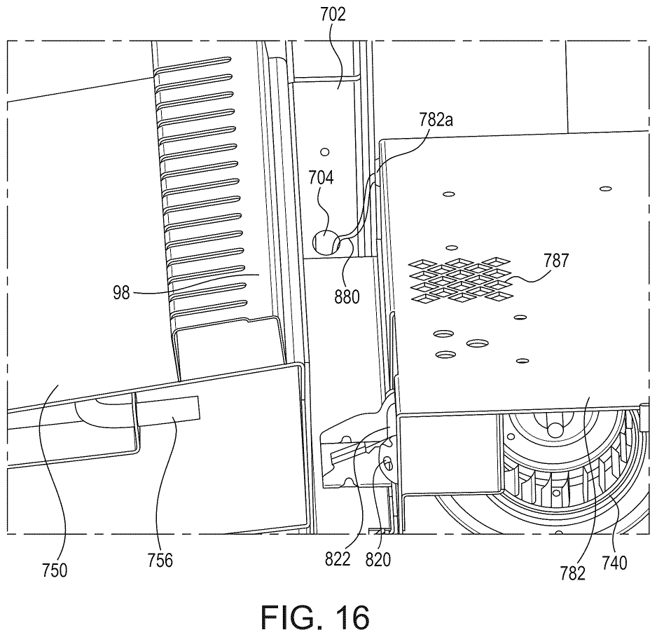

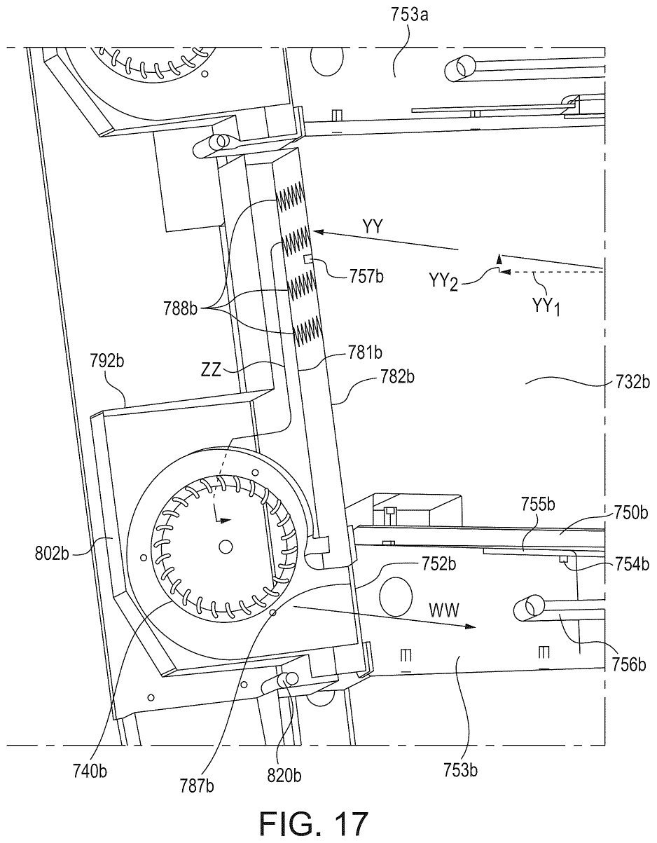

Turning now to FIGS. 12-17 another heated display cabinet 700 is provided. The cabinet 700 performs the same functions as cabinets 10 and 500 discussed above unless described differently below. Briefly, the cabinet 700 is provided with multiple different shelves that are disposed stacked vertically with respect to each other, with each shelf configured to support a plurality of food items therein in an organized fashion and in a manner that is adapted for a user that stands in front of the cabinet to readily identify the contents within the cabinet and access and remove the contents that are desired-such as to be purchased when the cabinet 700 is used in a store or a restaurant. The cabinet 700 includes a heating system 760 to selectively heat all or various shelves within the cabinet (as operated by a controller 1000 (FIG. 14, schematic)), with the heat flowing by conduction through the shelf to the bottom of items that rest upon the shelf and by convection due to an air flow through the space 732 above the shelf 750 such that the convection air flow may assist in maintaining the items stored upon the shelf in a warm condition when desired. The cabinet may include one or more shelves that also or alternatively include cooling capability. The air flow within the space 732 may establish an air curtain that has many beneficial effects. The same structure in cabinet 700 that is provided in one or more of cabinets 10 and 500 are identified with like reference numbers and if certain structure that is depicted in FIGS. 12-16 but not specifically described here, that structure is like the related structure from the above embodiments as described above.

The controller 1000 may be controlled by feedback control to maintain certain shelves within certain temperature ranges, as selected by the operator, as communicated such as from a central server, or with reference to identified (either automatically or via inputs by the user) of what foods are disposed upon the respective shelves. The controller 1000 may communicate with an input device at the rear wall of the cabinet, or with a remote source of instructions.

In the embodiment depicted in the figures, the cabinet includes three shelves 750 and three mechanical compartments 780 that are rotatable with respect to each shelf 750 to selectively allow or prevent access to each shelf 750 from a rear side of the housing 720, as discussed in further detail below. In other embodiments, the cabinet 700 could have 2 or more than 3 shelves that are arranged vertically with respect to each other to establish a plurality of spaces 732 to hold and display food items thereon. Unless discussed specifically, all three of the sets of shelves 750 and mechanical compartments 780 (discussed below)—and specifically all of the structural items associated with the shelves and mechanical compartments (and space 732 above the shelf) are identified with the same element numbers, but with the letter “a” associated with each element number for the upper most shelf/mechanical compartment, the letter “b” associated with each element number for the middle shelf/mechanical compartment, and the letter “c” associated with each element number for the bottom shelf/mechanical compartment. Any specific differences between the three shelves/mechanical operation, either in structure or in operation, is specifically discussed herein, and therefore for the sake of brevity, several details associated with the middle shelf (“b”) are discussed in detail here and depicted in the figures, with this structure being applicable to the upper and bottom shelves (“a” and “c”, respectively) unless otherwise discussed herein. For the sake of brevity the discussion of an element number that applies equally to all shelves/mechanical compartments will be used with a discussion of the element number without the a, b, or c suffix (i.e. 750 equally refers to shelves depicted as 750a (upper), 750b (middle) and 750c (lower)) unless specifically discussed differently.

In some embodiments, the cabinet 700 includes a plurality of shelves 750 such as three, four, or five shelves, that each have the same size and orientation and each extend within the internal volume 710 of the housing 702, with the space above each shelf identified as 732. The housing has right and left walls 725, 724, a top wall 723, and a bottom wall (bottom of housing in FIGS. 11), 721. In some embodiments, each of the plurality of shelves 750 may extend in the same orientation within the housing such that the shelves are each parallel to each other. In some embodiments, each shelf 750 may extend along or parallel to a line that is at an acute angle (Θ) to the surface 2000 that housing rests upon in the same manner as described above with respect to shelfs 750. In these embodiments, the acute angle Θ may be aligned such that a front portion of each shelf (proximate to the open front 704 is at a lower position than the remainder of the shelf, such that the force of gravity acting upon the food items within the shelf tend to urge the food products toward the front portion of the shelf (assuming that the mass of the food item allows the food item to slide upon the top surface of the shelf 750 due to the force of gravity). In some embodiments, the acute angle Θ may be about 20, or about 25, or about 30 degrees. In some embodiments, the acute angle may be within a range of about 10 degrees to about 30 degrees, inclusive of all angles within this range. The term “about” is defined to include the recited term plus or minus 10% of the value of the recited term.

The shelves 750 may each extend through the inner volume 710 of the housing 701 from the rear portion (where the front wall 782 of the mechanical compartment 780 is aligned when in the closed position, discussed below) and to a position where a front end portion is proximate to the front opening into the internal volume 710 of the housing. Each shelf may include a top surface 751 that may be a flat surface, or may have raised features, such as to align various contents upon the shelf into rows. Each shelf may extend across the entire width of the housing, and specifically the inner volume of the housing, while in other embodiments, each shelf may extend only a portion of the width of the housing and be spaced from the right and left side walls 725, 725 of the housing 20.

The shelves 750 define a storage volume 732 that is within the inner volume 710 of the housing, and specifically within the space above the shelf 750 and below a roof 738 that is spaced above the shelf and faces the shelf 750 (the roof 738 is either formed by a bottom surface of the shelf that is above the storage volume, or for the upper most storage volume 732a, the roof is formed by a bottom surface of an upper compartment in the housing 701. The storage volume 732 is the volume above the shelf 750 that the food products are received and arranged. In some embodiments the roof 738 is parallel with the shelf 750 that is positioned directly below the roof 738.

One, some, or all of the shelves 750 include a stand-off 758 that is disposed at or proximate to a forward portion 750. The stand-off 758 is a portion that is either formed monolithically with the shelf or is attached to the shelf and extends upwardly above the upper surface of the shelf 750. The stand-off 758 may extend across the entire width of the shelf or for one or more portions of the width. A front surface of the stand-off may be flush with a front surface of the shelf, or the front surface of the stand-off may be positioned behind the front surface. The front portion of the shelf 750 preferably includes a plurality of apertures, not specifically shown but formed to allow air flow to leave the inner volume 753 of the shelf 750 and into the storage volume 732 as schematically depicted as air flow XX in FIG. 14. The stand-off 758 may include structure to redirect the air flow XX so that it flows through the storage volume 732 as schematically depicted in FIG. 14 as air flow YY. Alternatively, the air redirection structure may be a part of the shelf and not the stand-off. Alternatively, or additionally (when not inconsistent with this description) the front portion of the shelf and the stand-off may be constructed as described with respect to the stand-off 68 and the shelf 52 in the embodiments discussed above. In embodiments with the stand-off 758, a rear stand-off 759 is also provided. The stand offs 758, 759 may have corresponding features that assist with supporting longitudinal dividers that extend in the front to back direction upon the shelf 750 as desired, and may be structured as described with the stand offs of the previous embodiments.

As discussed above, the shelf and/or the stand-off may cause the air flow within the storage volume 732 to follow direction YY (nominally unless redirected by one or more food items or other items resting upon the shelf 750 within the storage volume 732), with the direction YY being generally rearwardly directed toward the first wall 782 of the mechanical compartment 780 when in the closed position, as discussed below. The direction YY may in some embodiments include vector components YY, that is in the horizontal direction (i.e. parallel to the surface that the cabinet 700 rests upon) and a vector component YY2 that is in the vertical direction (perpendicular to the surface that the cabinet 700 rests upon). The direction of flow in the YY direction may be influenced by both the structure of the shelf/standoff that redirects the air flow leaving the shelf (flow XX) as well as the fans 740 within the mechanical compartment 780 and draw a suction that is communicated through the plurality of apertures 784 in the first wall 782 when in the closed position, whereby the first wall encloses the back of the storage volume 732.

With reference to FIG. 14, the heating system 760 is provided, and is operated by the controller 1000. In some embodiments, the controller 1000 may constantly operate the heating system with feedback control, while in other embodiments one or both of the heaters associated with the heating system 760 may be continuously on or operated based upon regimented schedule based upon the elapse of time, or operated based upon the presence or absence of specific food products that are disposed upon the respective shelf.

The heating system 760 may be operated independently for each shelf 750 by the controller. In the embodiment depicted in the figures, the heating system 760 includes a conduction heater 755 which is disposed below and in contact with the shelf surface 751 such that heat generated by the conduction heater 755 conducts thought the shelf surface 751 and to the food item that is disposed upon the shelf surface 751 (and other heat is either radiated into the internal volume of the shelf and transferred by convection to the air that flows through the internal volume 753 in air flows WW and XX (FIG. 14, schematic). A heat sensor 754, such as a thermocouple, is provided in contact with the conduction heater 755, and either between the conduction heater 755 and the shelf surface 751, or as in FIG. 14 below the conduction heater 755. The controller 1000 may operate the conduction heater 755 (when operated by feedback control) based upon the temperature identified by the heat sensor 754, such as to keep the sensed temperature within a range, or based upon a recipe associated with certain foods that are expected to be received (or known to be received) upon the shelf 750. The convection heater 755 may be planar and of very narrow thickness to minimize the blockage of air flow through the internal volume 753.

The heating system 760 may further include a convection heater 756 that is disposed within the internal volume 753. The convection heater 756 may be an electrical heating element similar to heating elements used within electric overs, such as an elongate cylindrical structure. The heater 756 is disposed within the internal volume 753 along the length of the internal volume (i.e. from the back portion toward the front portion) and may be straight, or may have zig zags or other bends to cause the air flowing through the internal volume 753 to cross across a large surface area of the convection heater 756. The convection heater when operating causes convection heat transfer to the air flowing through the internal volume (air flows WW and XX) and may radiate heat into the internal volume.

In embodiments where the convection heater 756 is controlled with feedback control, a temperature sensor 757 is provided within the air flow path with respect to the shelf 750 and the related mechanical compartment 780 with the controller 1000 operating the convection heater 756 as needed to control the air temperature flowing past the temperature sensor 757. In a preferred embodiment depicted in the figures, the temperature sensor 757 is within the mechanical compartment, and may be fixed to an inner surface of the front wall 782—or fixed to another structure such to interact with air that flows through the plurality of inlet apertures 786 (air flow ZZ) before the air reaches the suction of the fan(s) 740 within the mechanical compartment. Alternatively, the temperature sensor 757 may within the internal volume of the shelf 753. The controller 1000 may alternatively control the operation of the convection heater 756 as always on, or with a duty cycle based upon elapsed time that items have been upon the respective shelf. The controller 1000 may operate the convection heater 756 differently to maintain the air temperatures within different ranges depending upon the types of foods that are received within the shelves 750.

As discussed above, a mechanical compartment 780 is associated with each shelf 750. The mechanical compartment 780 includes one, two or more fans 740 that draw suction from air within the mechanical compartment 780 (and specifically air that has flowed into the mechanical compartment from the storage volume 730) and blows air into the internal volume 753 of the respective shelf 750 associated with the mechanical compartment 780.

The mechanical compartment 780 is enclosed by a first wall 782, and a second wall 792, and a remaining wall 802. The walls provided a barrier to the components within the mechanical compartment for the outside thereof and in some embodiments may be insulated to minimize the heat within the mechanical compartment from transferring through the walls of the mechanical compartment—particularly the second wall 792 and the remaining wall 802 (both for efficiency purposes and to minimizing the temperature of the components of the housing 701 that may be hot to the touch.

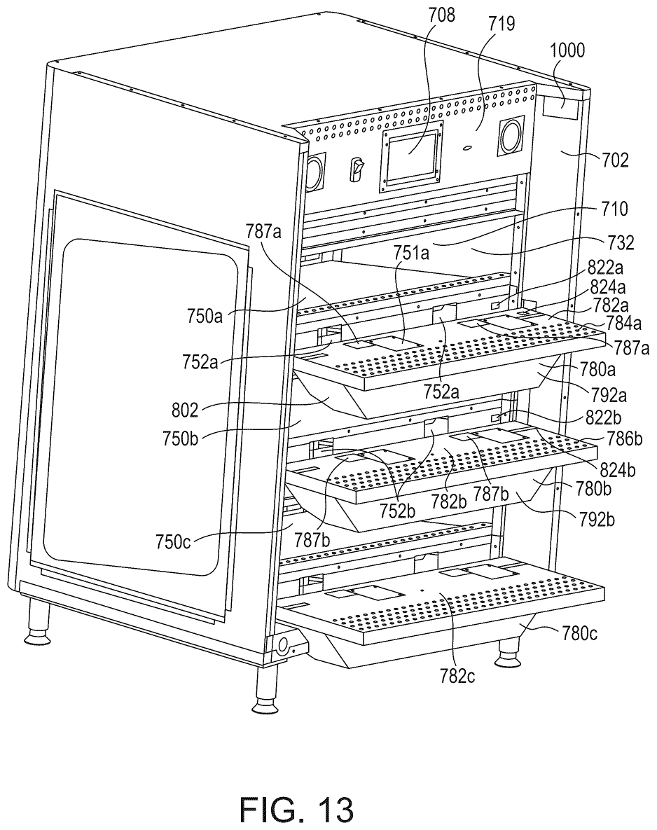

The mechanical compartment 780 is rotatably mounted with respect to each shelf 750 between a closed position (FIG. 12) and an open position (FIG. 13). When in the closed position, the first wall 782 of the mechanical compartment 780 is aligned above the shelf 750 at a rear end of the shelf and establishes a back wall within the space 732 above each shelf 750. The first wall 782 in the closed position either contacts the rear end 751 of the shelf 750 or is in very close proximity to the rear end 751 of the shelf (i.e. within millimeters). The first wall 782 one or two (or more) of apertures 787 (specifically the same number of apertures 787 as fans) that allow flow from the mechanical compartment 780 and into the internal volume 753 of the shelf 750 through a corresponding aperture(s) 752 in the rear wall of the shelf. Each of the aperture 787 may be a single aperture or preferably a large number of closely spaced small apertures to prevent or minimize foreign material from fall through the apertures 787 and into the fan 740 that is aligned with the fan discharge flowing directly to the apertures 787. Similarly the shelf aperture 752 may be a plurality of closely spaced small apertures 752 to prevent foreign material introduction in the shelf interior volume 753.

The first wall 782 further includes a set of inlet apertures 786 that are aligned to allow air to flow from the storage volume 732 and into the mechanical compartment. When in the closed position, the second wall 792 is disposed at the top of the mechanical compartment. The remaining wall 802 may be one or more walls that enclose the rear side (i.e. the side that faces away from the internal volume 710 of the housing 701 when in the mechanical compartment when in the closed position, the right and left sides, and the bottom side (when in the closed position).

When in the open position (FIG. 13) the first wall extends away from the respective shelf 750, and extends horizontally, or at an angle that is only a small angle away from the horizontal (e.g. less than 15 degrees from the horizontal). As shown in FIG. 13, the first wall 782 is disposed at a lower level than the shelf surface 751 such that the mechanical compartment associated with the shelf and the first wall provides no or minimal interference with placing items onto the shelf surface 751 through the rear opening into the housing provided when the mechanical compartment 780 is in the open position.

In preferred embodiments, during use, the cabinet 700 is designed such that only one mechanical compartment 780 is preferably opened at one time, such that, for example, if the middle mechanical compartment 780b is pivoted to the open position, the top mechanical compartment 780a is maintained in the closed position, and therefore the top mechanical compartment 780a does not provide any (or limited) interference with placing items onto the shelf surface 751a of the middle shelf 750a through the rear opening.

When the mechanical compartment is in the open position, at least a portion of the second wall 792 extends vertically and faces horizontally (or close to horizontally with a minimal offset angle, similar to the offset angle from the first wall 782 discussed above). The remaining wall 802 has a portion that faces the housing 701 and portions that face downwardly (as well as portions that continue to face to the left and right.

In some embodiments, the mechanical compartment 780 may include a lock 810 that can be operated to removably fix the mechanical compartment 780 in the closed position. The lock may be associated with a handle, such that the lock can be ergonomically operated by the user with a single hand when they manipulate the handle with the intent of rotating the mechanical compartment 780 from the closed position to the open position. The lock 810 may include a bar (not show) that is biased toward receipt within a corresponding recess within the housing 701 when in the closed position, and with operation of the lock 810 the bar is removed from the recess to allow the mechanical compartment to be rotated toward the open position.

The cabinet 700 may include a closed position sensor (822a) that can identify when the mechanical compartment 780 is in the fully closed position. The sensor 822a may be a mechanical sensor that is pressed when the first wall 782 presses thereon when the mechanical compartment is in the fully closed position and is released when not in the fully closed position. Alternatively, the sensor may be a magnetic sensor, or an electric sensor that establishes a signal when the first wall 782 is in the fully closed position and does not establish a signal when the first wall 782 is not in the fully closed position—or vice versa—there is a signal when the first wall is not in the fully closed position and no signal when the first wall is in the fully closed position. Other types of sensors may be used that can establish when the first wall is in the fully closed position, or when the first wall is not in the fully closed position. The closed position sensor 822a sends a signal to the controller 1000. The controller 1000 may include a fan interlock that prevents operation of the fan(s) 740 within the respective mechanical compartment 780 when a signal indicative of the first wall 782 being in the fully closed position is not received.

With specific reference to FIGS. 13, 14, and 14a the air flow through the shelves 750, the storage volume 732 above each respective shelf, and the mechanical compartment 780 described. During operation of the fan(s) 740 air flows from the discharge of the fan(s) through the apertures 787 in the first wall 782, and through the apertures 752 in the shelf 750 and into the interior volume 753 of the shelf 750 (schematically depicted as WW). Air then flows through the interior volume 753 of the shelf 750 and past the convention heater 756 and across the conduction heater 755, with the air gaining heat from the heaters when they operate (flow XX). Air flows out of the shelf 750 at or proximate to the front end and into the space 732 above the respective shelf. The air flows within the space 732 in the general direction YY as discussed above. Air then flows into through the plurality of air inlet apertures 786 and into the mechanical compartment (ZZ) and the air flows to the fan suction 740.

As best depicted in FIGS. 14, 14, and 14a, each mechanical compartment may rotate to an open position where the mechanical compartment 780 is rotated away from the rear opening into the space 732 to allow for access into the space 732 from behind the housing 701. The first wall 782 establishes a horizontal or substantially horizontal (as discussed above) orientation that allows for passage of items into the space 732 and above the first wall 782. In some embodiments, when the mechanical compartment that is to be opened (e.g. 780b) reaches the open position, a portion of the outer wall of the mechanical compartment 780 (e.g. the remaining wall 802) contacts either the housing 701 or the second wall of the mechanical compartment 780c that is directly below the mechanical compartment 780b that is being rotated. FIG. 14a shows the mechanical compartment 780b in a position just before it makes contact with the second wall 792 of the mechanical compartment 780c directly below. The contact between the mechanical compartment 780 being rotated with the mechanical compartment directly below establishes the potential range of motion of the mechanical compartment with respect to the housing 701. In some embodiments, a second stop (not shown) upon the housing 701 is provided that the mechanical compartment contacts when the mechanical compartment directly below is also in the open position to establish the range of motion of the mechanical compartment being rotated in that circumstance.

The mechanical compartment 780 can be rotated between the open and closed positions by manipulating the handle 810.

In some embodiments, the mechanical compartment 780 is connected with respect to the housing 701 with one or more hinges 820. In one embodiment, one or more piano hinges or door hinges 820 are provided with one half of the hinge connected to the mechanical compartment 780 (and specifically to the remaining wall 802) and the other portion contacting the housing 701 and in some embodiments structure associated with the corresponding shelf 750.

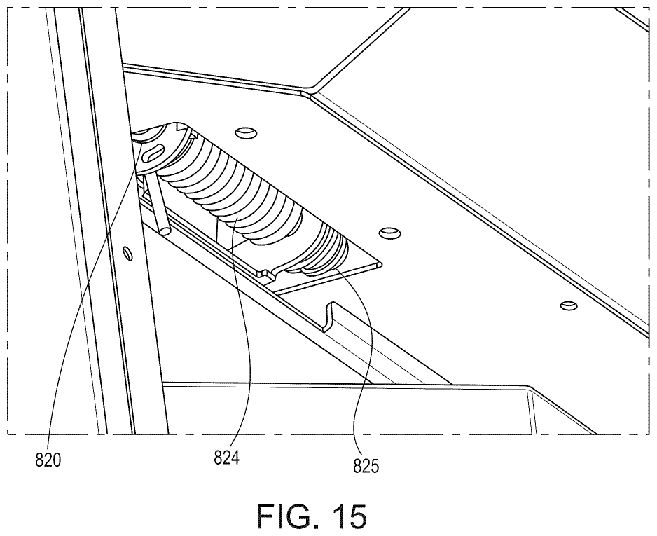

In some embodiments a spring loaded hinge 824 as depicted in FIG. 15. The spring may be a torsion spring and bears against both the mechanical compartment 780 and the housing/shelf and is aligned to urge the mechanical compartment 780 toward the closed position. As the mechanical compartment 780 is initially rotated away from the closed position the spring provides a resistive force against the rotation, which felt as some resistance by the user during rotation. At a point in the travel, the weight of the mechanical compartment 780, and specifically the center of mass, translates away from the housing and the weight of the mechanical compartment 780 begins to assist in the rotation toward the open position, where the effect of the offset of the center of mass from above the hinge overcomes the counter force of the spring 824. In some embodiments, the spring loaded hinge 824 may be adjustable—such as by tightening or loosening a nut 825 on the end of the spring, which alters the spring constant and allows for adjustment of the biasing force upon the mechanical compartment 780 and the neutral position within the rotational travel of the mechanical compartment where the offset of the center of mass overcomes the spring force to allow the mechanical compartment 780 to remain in the open position. The spring loaded hinge 824 provides a biasing force to urge the mechanical compartment toward the closed position.

In some embodiments, the inner wall 782 may include one or more apertures 782 that allow for electrical wires 850 (schematic) to extend therefrom, with the wires being used to control and provided power to the fan(s) 740 and in some embodiments to control operation of the fan(s) as well as to provide for communications and power to the temperature sensor 757 when provided within the mechanical compartment 780. The housing 701 may include a complementary hole 704 that is proximate to the aperture(s) 782 to receive the electrical wires. The wires 850 may extend between the holes with sufficient slack to allow the mechanical compartment to freely move between the open and closed positions without the wires 850 providing any resistance to movement.

In some embodiments, the rear side 719 of the housing 701 may include one or more digital displays 708. The digital displays 708 may be customer focused and communicate the same information as provided upon the displays 57 discussed with respect to the embodiments below. Alternatively, the digital displays 708 may be employee focused and may communicate information to employees regarding the inventory within the cabinet 700, the time that the inventory has been within the cabinet including any requirements to remove any old food from the display, or to remove any food from the display when a change in strategy for the contents of the display are received-as discussed with respect to the embodiments above.

In some embodiments, the shelves 750 may each include two or more lights 600 that are positioned above the respective shelf to provide illumination to the shelf 750, and the contents upon the shelf. The lights 600 operate in a similar manner to the lights as discussed with respect to the embodiments above.

Certain aspects of the disclosure are embodied by the following numbered paragraphs:
Numbered Paragraph 1: A cabinet comprising:
a housing with a top wall, right and left side walls, a lower wall and a rear wall that are collectively arranged to define an internal volume therein, wherein the housing includes an open front to allow access into the internal volume;
a plurality of shelves that extend within the internal volume, wherein each of the plurality of shelves have a storage volume disposed above the respective shelf, wherein each storage volume is a part of the internal volume, wherein each of the plurality of shelves comprises a conduction heater disposed on the respective shelf that adds heat to a top surface of the respective shelf;
wherein each of the plurality of storage volumes is partially enclosed by a roof within the internal volume and above the respective storage volume, wherein the roof includes an air flow path therethrough and a plurality of apertures at an end of the roof proximate to the open front, wherein the plurality of apertures direct air flowing from the air flow path into the storage volume below the roof in an air flow direction that leaves the plurality of apertures in a substantially a downward direction;
further comprising a heating assembly that is provided in conjunction with each shelf and storage volume, wherein each heating assembly comprises a fan, a heating element, and at least one sensor, wherein the at least one sensor monitors a temperature of air flowing through the roof above the respective storage volume;
further comprising a controller, the controller is configured to control operation of the respective fan, the respective heat element, and the respective heater disposed with the shelf of the plurality of shelves associated with the respective storage volume, wherein the controller selectively operates the respective conduction heater, the respective heating element, and the respective fan to control a sensed temperature of air that flows through the air flow path above the respective storage volume.
Numbered Paragraph 2: The cabinet of Numbered Paragraph 1, wherein each shelf comprises a first standoff disposed at a front portion thereof proximate to the open front.
Numbered Paragraph 3: The cabinet of Numbered Paragraph 2, wherein each first standoff comprises a plurality of apertures therein.
Numbered Paragraph 4: The cabinet of Numbered Paragraph 3, wherein each of the plurality of apertures are disposed with consistent spacing between adjacent apertures.
Numbered Paragraph 5: The cabinet of any one of Numbered Paragraphs 3 or 4, wherein each of the plurality of apertures extend along an upward facing surface of the standoff and transition to a surface that faces the rear wall of the housing.
Numbered Paragraph 6: The cabinet of any one of the preceding Numbered Paragraphs, wherein the rear wall of the housing has a plurality of sets of apertures, wherein each set of apertures of the plurality of apertures is aligned above each of the respective plurality of shelves.
Numbered Paragraph 7: The cabinet of Numbered Paragraph 6, wherein each heating assembly is disposed within a heating volume of a plurality of heating volumes, wherein each respective heating volume of the plurality of heating volumes is fixed to the rear wall proximate to the associated shelf such that each heating assembly encloses the respective heating element and fan of the respective heating assembly, wherein the set of apertures aligned above each respective shelf allows air flow into the respective heating assembly disposed proximate to the respective shelf.
Numbered Paragraph 8: The cabinet of any one of the preceding Numbered Paragraphs, wherein the heating assembly comprises angled divider disposed therein, the angled divider extends across the heating assembly above the plurality of holes and directs air entering through heating assembly through the plurality of holes to a suction of the fan.
Numbered Paragraph 9: The cabinet of either one of Numbered Paragraph 8, wherein the heating element is disposed below the angled divider such that air entering into the heating assembly passes across or proximate to the heating element before flowing into the suction of the fan.
Numbered Paragraph 10: The cabinet of Numbered Paragraphs 8 or 9, wherein the discharge of the fan directs air into the air flow path within the roof.
Numbered Paragraph 11: The cabinet of any one of the preceding Numbered Paragraphs, wherein the at least one sensor is disposed within the air flow path.
Numbered Paragraph 12: The cabinet of any one of the preceding Numbered Paragraphs, further comprising a second sensor associated with each shelf, wherein each second associated is disposed proximate to a top surface of the shelf.
Numbered Paragraph 13: The cabinet of Numbered Paragraph 5, wherein each shelf has a second standoff that is proximate to or in contact with the rear wall of the housing, wherein the second standoff comprises a plurality of apertures therein, wherein the plurality of apertures in the first standoff are arranged in the same alignment as the plurality of apertures in the second standoff.
Numbered Paragraph 14: The cabinet of Numbered Paragraph 13, wherein the housing further comprises a plurality of dividers that can extend within an aperture in the first standoff to an aperture within the second standoff.
Numbered Paragraph 15: The cabinet of Numbered Paragraph 1, wherein each shelf has a forward facing surface that extends proximate to the open front of the housing, wherein each forward facing surface supports a display screen, wherein the controller is configured to operate the display screen to include one or more of numbers, words, symbols, or pictures that are associated with items that are intended to be disposed within the storage volume above the respective shelf.
Numbered Paragraph 16: The cabinet of Numbered Paragraph 15, wherein the display screen is configured to allow for a continuously moving display.
Numbered Paragraph 17: The cabinet of Numbered Paragraph 16, the display screen is configured to display the types and amounts of items that are included within the respective storage volume, and include price and/or biographic information associated with the items that are within the storage volume.
Numbered Paragraph 18: The cabinet of any one of Numbered Paragraphs 1-17, wherein the plurality of apertures at the end of the roof are positioned along two parallel lines that are each parallel to a front face of the housing, wherein a first of the two parallel lines closest to the open front include more apertures than the apertures that form the second line further from the open front.
Numbered Paragraph 19: The cabinet of any one of Numbered Paragraphs 1-18, wherein the plurality of apertures at the end of the roof are positioned along two parallel lines that are each parallel to a front face of the housing, wherein the apertures in the first of two parallel lines are each evenly spaced across a width between the left and right sides of the housing, and the apertures in the second of the two parallel lines are established in a plurality of groups, wherein each aperture within each group are evenly spaced with a first spacing from adjacent apertures within the groups and the outermost aperture within each group is spaced from a closest aperture within an adjacent group at a second spacing that is greater than the first spacing.
Numbered Paragraph 20: The cabinet of Numbered Paragraph 18 or 19, wherein each of the apertures within the second of the two parallel lines are positioned to be aligned with a mid-point of a space between two adjacent apertures within the first line of the two parallel lines.
Numbered Paragraph 21: The cabinet of any one of Numbered Paragraphs 1-20, wherein a roof above each of the plurality of shelves includes one or more lights that shines light onto the shelf therebelow, wherein the controller controls the operation of each light.
Numbered Paragraph 22: The cabinet of Numbered Paragraph 21, wherein each shelf has a forward facing surface that extends proximate to the open front of the housing, wherein each forward facing surface supports a display screen, wherein the controller is configured to operate the display screen to include one or more of numbers, words, symbols, or pictures that are associated with items that are intended to be disposed within the storage volume above the respective shelf, wherein the controller is configured to operate the light upon the roof above the shelf and the display screen associated with the shelf in a constant manner such that the light and the display screen are operated collectively to identify or call attention to items that are disposed upon the respective shelf.
Numbered Paragraph 23: The cabinet of any one of Numbered Paragraphs 1-22, wherein the air flow path above the roof is formed with a decreasing height along the shelf as the shelf approaches the open front of the housing.
Numbered Paragraph 24: The cabinet of Numbered Paragraph 23, wherein the air flow path above the roof establishes a venture within the respective air flow path.
Numbered Paragraph 25: A cabinet comprising:
a housing with a top wall, right and left side walls that are collectively arranged to define an internal volume therein, wherein the housing includes an open front to allow access into the internal volume;
a plurality of shelves that extend within the internal volume, wherein each of the plurality of shelves establish a storage volume disposed above the respective shelf, wherein each storage volume is a part of the internal volume,
wherein each of the plurality of shelves comprises a heating assembly that is fixed with respect to the respective plurality of shelves;
wherein each of the plurality of storage volumes is partially enclosed by a roof within the internal volume and above the respective storage volume and the respective shelf, each storage volume is further enclosed by the right and left walls;
wherein the housing pivotably supports a plurality of mechanical compartments, with one of the plurality of mechanical compartments disposed with respect to each shelf, each mechanical compartment is pivotably mounted to the housing and pivotable between a closed position where a first wall of the mechanical compartment forms a rear wall of the storage volume, and between an open position wherein the storage volume is accessible above the mechanical compartment and from a direction opposite from the open front of the housing;
wherein the heating assembly is provided in conjunction with each shelf and each mechanical compartment, wherein each heating assembly comprises a fan, a heating element, and at least one sensor, wherein the at least one sensor monitors a temperature within one of the mechanical compartment or the shelf;
further comprising a controller, the controller is configured to control operation of the respective fan and the respective heating assembly.
Numbered Paragraph 26: The cabinet of Numbered Paragraph 25, wherein each mechanical compartment of the plurality of mechanical compartments comprises the first wall, a second wall, and an enclosure wall that are each fixed with respect to each other to establish an internal volume of the mechanical compartment, when the respective mechanical compartment is aligned in the closed position the first wall is disposed in contact or in very close proximity with the shelf of the plurality of shelves that is disposed with respect to the mechanical compartment, wherein when in the closed position, the first wall is substantially vertical, and the second wall is disposed to enclose the top portion of the mechanical compartment, wherein when in the open position, the first wall is substantially horizontal.
Numbered Paragraph 27: The cabinet of any one of Numbered 26, wherein the each of the plurality of shelves have a rear wall that encloses the shelf, each rear wall comprising one or more first apertures, wherein the first wall of each mechanical compartment comprises one or more corresponding second apertures that are aligned with the respective one or more first apertures when the respective mechanical compartment is in the closed position to allow air flow from the mechanical compartment through the respective aligned second and first apertures and into an internal volume of the respective shelf.
Numbered Paragraph 28: The cabinet of any one of Numbered Paragraphs 25-27, wherein the heating assembly comprises a conduction heater fixed to the respective shelf, such that during operation of the conduction heater heat flows through the respective shelf toward the storage volume above the respective shelf.
Numbered Paragraph 29: The cabinet of Numbered Paragraph 28, further comprising a temperature sensor disposed in contact with the respective conduction heater fixed to the respective shelf of the plurality of shelves, wherein the controller selectively operates the respective conduction heater to control the amount of heat produced by the conduction heater.
Numbered Paragraph 30: The cabinet of any one of Numbered Paragraphs 28-29, wherein the heating assembly further comprises a second heater disposed within the shelf, and the at least one sensor comprises a temperature sensor disposed within the mechanical compartment, wherein the controller controls the operation of the second heater to maintain the air that flows past the temperature sensor.
Numbered Paragraph 31: The cabinet of Numbered Paragraph 30, wherein the each of the plurality of shelves have a rear wall that encloses the shelf, each rear wall comprising one or more first apertures, wherein the first wall of each mechanical compartment comprises one or more corresponding second apertures that are aligned with the respective one or more first apertures when the respective mechanical compartment is in the closed position to allow air flow from the mechanical compartment through the respective aligned second and first apertures and into an internal volume of the respective shelf,
wherein air entering the shelf through the one or more second apertures in the first wall the air passes by the second heater, and then flows out of the shelf through one or more apertures disposed within the shelf proximate to the open front of the housing, wherein a front portion of the shelf is configured to direct air flowing through or received from the one or more apertures in a direction with a horizontal vector component toward the first wall of the mechanical compartment, wherein air flowing out of the shelf flows toward the first wall of the mechanical compartment and through a plurality of inlet apertures within the first wall and disposed vertically above the one or more corresponding second apertures.
Numbered Paragraph 32: The cabinet of Numbered Paragraphs 26-31, wherein each of the plurality of mechanical compartments are independently pivotably mounted with respect to each respective shelf within the housing, wherein when a first mechanical compartment of the plurality of mechanical compartments is in the closed position and a second mechanical compartment of the plurality of mechanical compartments that is directly above the first mechanical compartment is in the open position, the enclosure wall of the second mechanical compartment contacts and rests upon the second wall of the first mechanical compartment.
Numbered Paragraph 33: The cabinet of Numbered Paragraphs 26-32, wherein the first wall of each mechanical compartment comprises a plurality of inlet apertures, such that the plurality of inlet apertures are aligned with the storage volume when the mechanical compartment is in the closed position, wherein operation of the fan causes a relatively lower pressure within the mechanical compartment that is communicated to the plurality of inlet apertures, which causes air within the storage volume to flow toward the first wall and through the plurality of inlet apertures and into the mechanical compartment to the fan.
Numbered Paragraph 34: The cabinet of any one of Numbered Paragraphs 26-33, further comprising a position interlock associated with each mechanical compartment, the position interlock comprises a sensor that is capable of identifying when the mechanical compartment is in the closed position, wherein when the sensor identifies that the mechanical compartment is in the closed position the fan can be operated by the controller and when the sensor does not identify that the first wall is in the closed position the fan is prevented from operation.
Numbered Paragraph 35: The cabinet of any one of Numbered Paragraphs 25-34, further comprising a lock associated with each mechanical compartment that when engaged fixes the mechanical compartment in the closed position, wherein when the lock is engaged the mechanical compartment is prevented from moving toward the open position.
Numbered Paragraph 36: The cabinet of any one of Numbered Paragraphs 25-35, wherein each of the plurality of mechanical compartments are pivotably connected with respect to the housing and the respective shelf with a hinge, wherein the hinge is configured to apply a resistive force that opposes rotation of the mechanical compartment from the closed position toward the open position, wherein the resistance is applied for a least a portion of the range of travel from the closed position toward the open position.
Numbered Paragraph 37: The cabinet of Numbered Paragraph 36, wherein the hinge comprises a torsion spring that is fixed to the mechanical compartment and bears upon one or both of the housing and the respective shelf that the mechanical compartment is associated with.
Numbered Paragraph 38: The cabinet of Numbered Paragraph 37, wherein the torsion spring is adjustable to adjust the spring constant of the spring that results in a proportional amount of change of the amount of resistance that is applied when the mechanical compartment is moved from the closed position toward the open position.
Numbered Paragraph 39: The cabinet of any one of Numbered Paragraphs 25-38, wherein each shelf has a forward facing surface that extends proximate to the open front of the housing, wherein each forward facing surface supports a display screen, wherein the controller is configured to operate the display screen to include one or more of numbers, words, symbols, or pictures that are associated with items that are intended to be disposed within the storage volume above the respective shelf.
Numbered Paragraph 40: The cabinet of Numbered Paragraph 39, wherein the display screen is configured to allow for a continuously moving display.
Numbered Paragraph 41: The cabinet of Numbered Paragraph 40, the display screen is configured to display the types and amounts of items that are included within the respective storage volume, and include price and/or biographic information associated with the items that are within the storage volume.
Numbered Paragraph 42: The cabinet of any one of Numbered Paragraphs 25-41, wherein a roof above each of the plurality of shelves includes one or more lights that shines light onto the shelf therebelow, wherein the controller controls the operation of each light.
Numbered Paragraph 43: The cabinet of Numbered Paragraph 42 wherein each shelf has a forward facing surface that extends proximate to the open front of the housing, wherein each forward facing surface supports a display screen, wherein the controller is configured to operate the display screen to include one or more of numbers, words, symbols, or pictures that are associated with items that are intended to be disposed within the storage volume above the respective shelf, wherein the controller is configured to operate the light upon the roof above the shelf and the display screen associated with the shelf in a constant manner such that the light and the display screen are operated collectively to identify or call attention to items that are disposed upon the respective shelf.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

1-24. (canceled)

25. A cabinet comprising:
a housing with a top wall, right and left side walls that are collectively arranged to define an internal volume therein, wherein the housing includes an open front to allow access into the internal volume;
a plurality of shelves that extend within the internal volume, wherein each of the plurality of shelves establish a storage volume disposed above the respective shelf, wherein each storage volume is a part of the internal volume,
wherein each of the plurality of shelves comprises a heating assembly that is fixed with respect to the respective plurality of shelves;
wherein each of the plurality of storage volumes is partially enclosed by a roof within the internal volume and above the respective storage volume and the respective shelf, each storage volume is further enclosed by the right and left walls;
wherein the housing pivotably supports a plurality of mechanical compartments, with one of the plurality of mechanical compartments disposed with respect to each shelf, each mechanical compartment is pivotably mounted to the housing and pivotable between a closed position where a first wall of the mechanical compartment forms a rear wall of the storage volume, and between an open position wherein the storage volume is accessible above the mechanical compartment and from a direction opposite from the open front of the housing;
wherein the heating assembly is provided in conjunction with each shelf and each mechanical compartment, wherein each mechanical compartment comprises a fan, and wherein an air flow path with respect to each shelf and mechanical compartment includes a heating element, and at least one sensor, wherein the at least one sensor monitors a temperature within one of the mechanical compartment or the shelf;
further comprising a controller, the controller is configured to control operation of the respective fan and the respective heating assembly.

26. The cabinet of claim 25, wherein each mechanical compartment of the plurality of mechanical compartments comprises the first wall, a second wall, and an enclosure wall that are each fixed with respect to each other to establish an internal volume of the mechanical compartment, when the respective mechanical compartment is aligned in the closed position the first wall is disposed in contact or in very close proximity with the shelf of the plurality of shelves that is disposed with respect to the mechanical compartment, wherein when in the closed position, the first wall is substantially vertical, and the second wall is disposed to enclose the top portion of the mechanical compartment, wherein when in the open position, the first wall is substantially horizontal.

27. The cabinet of claim 26, wherein the each of the plurality of shelves have a rear wall that encloses the shelf, each rear wall comprising one or more first apertures, wherein the first wall of each mechanical compartment comprises one or more corresponding second apertures that are aligned with the respective one or more first apertures when the respective mechanical compartment is in the closed position to allow air flow from the mechanical compartment through the respective aligned second and first apertures and into an internal volume of the respective shelf.

28. The cabinet of claim 25, wherein the heating assembly comprises a conduction heater fixed to the respective shelf, such that during operation of the conduction heater heat flows through the respective shelf toward the storage volume above the respective shelf.

29. The cabinet of claim 28, further comprising a temperature sensor disposed in contact with the respective conduction heater fixed to the respective shelf of the plurality of shelves, wherein the controller selectively operates the respective conduction heater to control the amount of heat produced by the conduction heater.

30. The cabinet of claim 28, wherein the heating assembly further comprises a second heater disposed within the shelf, and the at least one sensor comprises a temperature sensor disposed within the mechanical compartment, wherein the controller controls the operation of the second heater to maintain the air that flows past the temperature sensor.

31. The cabinet of claim 30, wherein the each of the plurality of shelves have a rear wall that encloses the shelf, each rear wall comprising one or more first apertures, wherein the first wall of each mechanical compartment comprises one or more corresponding second apertures that are aligned with the respective one or more first apertures when the respective mechanical compartment is in the closed position to allow air flow from the mechanical compartment through the respective aligned second and first apertures and into an internal volume of the respective shelf,
wherein air entering the shelf through the one or more second apertures in the first wall passes by the second heater, and then flows out of the shelf through one or more apertures disposed within the shelf proximate to the open front of the housing, wherein a front portion of the shelf is configured to direct air flowing through or received from the one or more apertures in a direction with a horizontal vector component toward the first wall of the mechanical compartment, wherein air flowing out of the shelf flows toward the first wall of the mechanical compartment and through a plurality of inlet apertures within the first wall and disposed vertically above the one or more corresponding second apertures.

32. The cabinet of claim 26, wherein each of the plurality of mechanical compartments are independently pivotably mounted with respect to each respective shelf within the housing, wherein when a first mechanical compartment of the plurality of mechanical compartments is in the closed position and a second mechanical compartment of the plurality of mechanical compartments that is directly above the first mechanical compartment is in the open position, the enclosure wall of the second mechanical compartment contacts and rests upon the second wall of the first mechanical compartment.

33. The cabinet of claim 26, wherein the first wall of each mechanical compartment comprises a plurality of inlet apertures, such that the plurality of inlet apertures are aligned with the storage volume when the mechanical compartment is in the closed position, wherein operation of the fan causes a relatively lower pressure within the mechanical compartment that is communicated to the plurality of inlet apertures, which causes air within the storage volume to flow toward the first wall and through the plurality of inlet apertures and into the mechanical compartment to the fan.

34. The cabinet of claim 26, further comprising a position interlock associated with each mechanical compartment, the position interlock comprises a sensor that is capable of identifying when the mechanical compartment is in the closed position, wherein when the sensor identifies that the mechanical compartment is in the closed position the fan can be operated by the controller and when the sensor does not identify that the first wall is in the closed position the fan is prevented from operation.

35. The cabinet of claim 25, further comprising a lock associated with each mechanical compartment such that when engaged the lock fixes the mechanical compartment in the closed position, wherein when the lock is engaged the mechanical compartment is prevented from moving toward the open position.

36. The cabinet of claim 25, wherein each of the plurality of mechanical compartments are pivotably connected with respect to the housing and the respective shelf with a hinge, wherein the hinge is configured to apply a resistive force that opposes rotation of the mechanical compartment from the closed position toward the open position, wherein the resistance is applied for a least a portion of the range of travel from the closed position toward the open position.

37. The cabinet of claim 36, wherein the hinge comprises a torsion spring that is fixed to the mechanical compartment and bears upon one or both of the housing and the respective shelf that the mechanical compartment is associated with.

38. The cabinet of claim 37, wherein the torsion spring is adjustable to adjust the spring constant of the spring that results in a proportional amount of change of the amount of resistance that is applied when the mechanical compartment is moved from the closed position toward the open position.

39. The cabinet of claim 25, wherein each shelf has a forward facing surface that extends proximate to the open front of the housing, wherein each forward facing surface supports a display screen, wherein the controller is configured to operate the display screen to include one or more of numbers, words, symbols, or pictures that are associated with items that are intended to be disposed within the storage volume above the respective shelf.

40. The cabinet of claim 39, wherein the display screen is configured to allow for a continuously moving display.

41. The cabinet of claim 40, the display screen is configured to display the types and amounts of items that are included within the respective storage volume, and include price and/or biographic information associated with the items that are within the storage volume.

42. The cabinet of claim 25, wherein a roof above each of the plurality of shelves includes one or more lights that shines light onto the shelf therebelow, wherein the controller controls the operation of each light.

43. The cabinet of claim 42 when depending from any one of claims 25-38 wherein each shelf has a forward facing surface that extends proximate to the open front of the housing, wherein each forward facing surface supports a display screen, wherein the controller is configured to operate the display screen to include one or more of numbers, words, symbols, or pictures that are associated with items that are intended to be disposed within the storage volume above the respective shelf, wherein the controller is configured to operate the light upon the roof above the shelf and the display screen associated with the shelf in a constant manner such that the light and the display screen are operated collectively to identify or call attention to items that are disposed upon the respective shelf.
